(19) United States
(12) Patent Application Publication
(10) Pub. No.: US 2021/0101313 A1
(43) Pub. Date: Apr. 8, 2021

(54) MULTILOBED POLYESTER PELLETS

(71) Applicant: The Coca-Cola Company, Atlanta, GA (US)

(72) Inventor: Ronald D. Moffitt, Spartanburg, SC (US)

(73) Assignee: The Coca-Cola Company, Atlanta, GA (US)

(21) Appl. No.: 16/607,978

(22) PCT Filed: Apr. 25, 2018
(86) PCT No.: PCT/US2018/029364

§ 371 Date: Oct. 24, 2019

Related U.S. Application Data
(60) Provisional application No. 62/490,071, filed on Apr. 26, 2017.

(51) Int. Cl. B29B 9/12; B29B 9/06; B29B 9/16; B29C 48/11; B29C 48/05; B29C 48/12

(52) U.S. Cl. CPC B29B 9/12; B29B 9/06; B29C 48/12; B29C 48/11; B29C 48/05; B29B 9/16

(57) ABSTRACT

Polyester multilobed prepolymer pellets and methods of making and using the same are provided. The multilobed polyester pellets have an increased surface area to volume ratio which improves intraparticle diffusion mass transfer rates resulting in a reduction of pellet drying and solid state polymerization processing times.

### CROSS REFERENCE TO RELATED APPLICATIONS

This application claims the benefit of priority to U.S. Provisional Patent Application No. 62/490,071, filed Apr. 26, 2017, which is hereby incorporated herein by reference in its entirety.

### FIELD OF THE DISCLOSURE

The present disclosure generally relates to polyester pellets for use in fabricating polymer-based packaging, particularly carbonated beverages.

### BACKGROUND OF THE DISCLOSURE

Poly(ethylene terephthalate) (PET) is a clear plastic belonging to the polyester family and is the world's packaging choice for many foods and beverages. Because it is hygienic, strong, lightweight, shatterproof, and retains freshness, PET is particularly suited to this application. It is most commonly used to package carbonated soft drinks and water. While PET has a number of desirable properties, PET manufacture currently requires using non-renewable resources.

Interest in poly(ethylene furanoate) (PEF) polyesters, also termed poly(ethylene-2,5-furandicarboxylate), as a potential replacement for PET has increased in recent years, largely due to the ability to synthesize PEF from bio-based sources. One goal has been to provide commercially viable PEF bottles or containers that have comparable or even superior properties such as barrier, thermal, and mechanical properties, compared to that of conventional PET bottles or containers. However, the wholesale use of PEF in conventional PET-based applications has proved difficult, particularly when the polyester is used for packaging beverages such as carbonated soft drinks.

One difficulty resides in the differences between the physical-chemical behavior of PEF versus PET. For example, compared to standard commercial grade PET, PEF polyesters often possess lower crystallinity, crystallize at slower rates, and are entangled to a lesser extent. The physical-chemical behavior differences present significant processing challenges that need to be addressed to produce more commercially viable PEF bottles.

High molecular weight polyesters, such as PET and PEF, are usually produced by a combination of melt polymerization and solid state polymerization (SSP) processes. Polyester prepolymers with relatively low molecular weight are typically produced in a melt polymerization process. For providing polyesters with higher molecular weights, solid state polymerization is generally carried out, which involves heating low molecular weight prepolymer “pellets” above their glass transition temperature but below their melting point.

One of the obstacles to producing commercially viable PEF bottles is that the mass transport rates of diluents via diffusion used in the SSP process for PEF are slow compared to PET that conventional drying or SSP conditions used for PET are not adequate to achieve the requisite performance. Therefore, there is a continuing need for new melt polymerization and solid state polymerization processes and new methods by which PEF pellets can be produced, manipulated or processed for wider use of PEF in conventional PET applications.

### SUMMARY OF THE INVENTION

According to an aspect, there are provided improved polyester prepolymer pellet forms that enhance prepolymer pellet drying and SSP rates and that offer reduced diffusion resistance to reaction by-products. The present disclosure addresses these and other related needs in the art. In some aspects and embodiments, the prepolymer pellets disclosed herein are shaped to include an externally convoluted surface to overcome the disadvantages of the prior pellets. In some aspects and embodiments, the prepolymer pellets disclosed herein are shaped to include an internally convoluted surface to overcome the disadvantages of the prior pellets. In some embodiments, the prepolymer pellets disclosed herein are shaped to include both an externally convoluted surface and an internally convoluted surface to overcome the disadvantages of the prior pellets.

In some aspects, a method for producing polyester pellets is provided, the method including extruding a polyester polymer melt through a multilobed capillary to form a multilobed polyester polymer strand; and separating the polyester polymer strand to form multilobed polyester resin pellets. In some embodiments, the pellet exterior has a multilobe shape (i.e. externally lobed) and the pellet interior is solid. In some embodiments, the pellet exterior has a multilobe shape and the pellet interior is hollow and multilobed (i.e. internally lobed). In some embodiments, the pellet exterior has a non-multilobe shape (e.g. cylindrical, round, elliptical, square, rectangular, etc.) and the pellet interior is hollow and multilobed. In some embodiments, internal lobes can connect and bridge during flow and drawdown to yield an internally supported, contiguous hollow structure. In some embodiments, the method for producing polyester pellets further includes quenching the multilobed polyester resin pellets and/or solid state polymerizing the multilobed polyester resin pellets under an inert gas or under partial vacuum. In some embodiments, the polyester is a poly(ethylene furanoate) or poly(ethylene furanoate) co-polymer, the multilobed polyester resin pellets can have a modification ratio of 1.05 or greater, and/or the multilobed polyester resin pellets can have three or more lobes if externally lobed and/or two or more lobes if internally lobed. For example, in some embodiments, the multilobed polyester resin pellets can have a polymer density of about 1.1-1.4 g/cm³ (25° C.) and a length of about 2-3 mm. In some embodiments, the multilobed polyester resin pellets can have a polymer density of about 1.3 g/cm³ (25° C.), a length of about 2.5 mm, a cross-sectional area of about 3.8 mm², and a volume of about 9-10 mm³. In some embodiments, the multilobed polyester resin pellets can have a diffusion ratio of about 0.55 or less relative to solid cylindrical pellets having the same mass. In some embodiments, the multilobed polyester resin pellets can have an intrinsic viscosity of about 0.25 dl/g or greater.

In some aspects, a method for preparing a polyester polymer is provided, the method including drying one or more multilobed polyester resin pellets and solid state polymerizing the one or more multilobed polyester resin pellets to form a polyester polymer having an intrinsic viscosity of about 0.65 dl/g or greater. In some embodiments, the one or more multilobed polyester resin pellets are dried at a temperature range from about 140° C. to 160° C. at a dew point temperature of about −40° C. for less than four days, and solid state polymerized to form a polyester polymer having an intrinsic viscosity of about 0.65 dl/g or greater. In some embodiments, the polyester polymer has an intrinsic viscosity of about 0.90 dl/g or greater.

### BRIEF DESCRIPTION OF THE DRAWINGS

Those of skill in the art will understand that the drawings, described below, are for illustrative purposes only. The drawings are not intended to limit the scope of the present teachings in any way.

FIG. 1 illustrates selected multilobed pellet cross-section shapes. The approximate modification ratios for the multilobed crossections shown are: (a) trilobal, MR=3.4, (b) pentalobal, MR=3.6, (c) heptalobal, MR=2.4, and (d) decalobal, MR=2.2.

FIG. 2 illustrates a graphic showing calculation of modification ratio.

FIG. 3 illustrates examples of capillary cross-section shapes for internally supported lobed (a,b) and externally-lobed pellet strand dies (c,d).

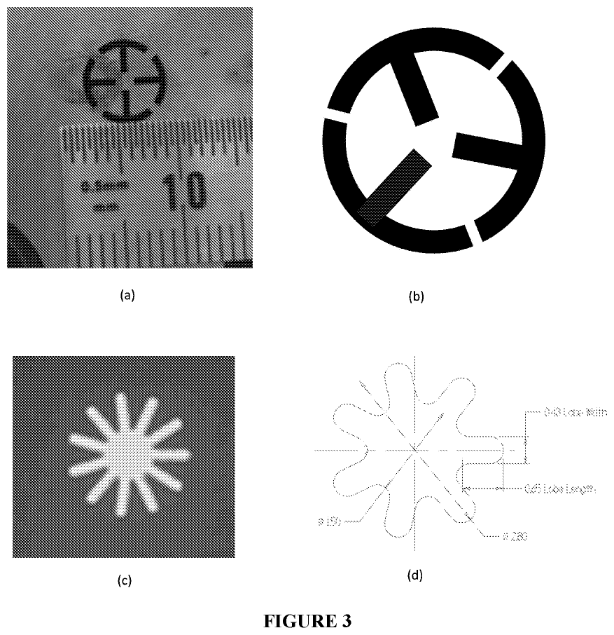

FIG. 4 illustrates a die and pellets produced with the hendecalobal pellet die: (a) views of the extrusion die face, (b) hendecalobal pellets compared to cylindrical pellets, and (c) close-up cross-section of a hendecalobal pellet.

FIG. 5 illustrates pellets produced with the 4T pellet capillary (a) and close-up of coalesced structure and shape definition (b).

### DETAILED DESCRIPTION OF THE INVENTION

Aspects will be set forth in part in the description that follows, and in part will be obvious from the description, or may be learned by practice of the aspects described below. The advantages described below will be realized and attained by means of the elements and combinations particularly pointed out in the appended claims. It is to be understood that the following detailed description is exemplary and explanatory only and is not restrictive.

In the following description, numerous specific details are given to provide a thorough understanding of embodiments. The embodiments can be practiced without one or more of the specific details, or with other methods, components, materials, etc. In other instances, well-known structures, materials, or operations are not shown or described in detail to avoid obscuring aspects of the embodiments.

Reference throughout this specification to “one embodiment,” “an embodiment,” or “embodiments” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Values or ranges may be expressed herein as “about”, from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed herein, and that each value is also herein disclosed as “about” that particular value in addition to the value itself. In aspects, “about” can be used to mean within 10% of the recited value, within 5% of the recited value, or within 2% of the recited value.

Any headings that may be employed herein are also not intended to be used to construe the scope of the claims or to limit the scope of the subject matter that is disclosed herein. Any use of the past tense to describe an example otherwise indicated as constructive or prophetic is not intended to reflect that the constructive or prophetic example has actually been carried out.

Unless indicated otherwise, when a range of any type is disclosed or claimed, for example a range of weight percentages, processing times, and the like, it is intended that the stated range disclose or claim individually each possible number that such a range could reasonably encompass, including any sub-ranges and combinations of sub-ranges encompassed therein. For example, when describing a range of measurements such as weight percentages, every possible number that such a range could reasonably encompass can, for example, refer to values within the range with more significant digits than are present in the end points of a range. For example, a weight percentage between 10 percent and 20 percent includes individually 10, 11, 12, 13, 14, 15, 16, 17, 18, 19, and 20 weight percent. Applicants reserve the right to proviso out or exclude any individual members of any such group, including any sub-ranges or combinations of sub-ranges within the group, if for any reason Applicants choose to claim less than the full measure of the disclosure.

The disclosure provides, among other things, methods and systems for increasing polyester pellet solid state polymerization and drying times. More particularly, multi-lobed resin pellets which have faster solid faster solid state polymerization and drying times without the disadvantages of existing techniques are provided. In some embodiments, the externally and/or internally multi-lobed resin pellets accelerate SSP and drying more than 300% relative to conventional cylindrical pellets.

High molecular weight polyesters, such as PET and PEF, are usually produced by a combination of melt polymerization and solid state polymerization (SSP) processes. Polyester prepolymers with relatively low molecular weight (evidenced by a relatively low intrinsic viscosity, “IV”) are typically produced in a melt polymerization process. The prepolymer melt is extruded through a die with multiple orifices to form molten strands that are quenched, solidified, and chopped into granules or pellets. There are, of course, other methods to convert polyester melt into granular form. Herein, for convenience, polyester prepolymer granules, regardless of their shape or method of forming, will be referred to as pellets.

Generally, the shape of the orifices in the extrusion die used to pelletize prepolymer is round, but orifices of other simple shapes can be used. Drooping of the molten prepolymer strands and/or some flattening actions of the pelletizing equipment can cause the cross-section of the resulting prepolymer pellets to be somewhat elongated and not exactly round; i.e., approximately elliptical.

For getting polyesters with higher molecular weights, i.e. higher IV values, solid state polymerization is carried out. Solid state polymerization involves heating low molecular weight prepolymer pellets above their glass transition temperature but below their melting point until a desired high molecular weight or IV is achieved. It is very difficult to polymerize higher IV polyester in the melt-phase because of the thermal degradation reactions occurring simultaneously and competing with the poly condensation reactions.

Prior to solid state polymerization, the low molecular weight prepolymer pellets may be dried to remove excess moisture. During this step, moisture diffuses from the pellet interior to the surface and drying times are diffusion limited. One way to reduce drying times while maintaining pellet size is to increase the surface area to volume ratio of the pellets. Practically all standard prepolymer pellets have round, elliptical, square, rectangular, or other simple cross-sections. However, these simple cross-sections have low surface area to volume ratios.

Solid state polymerization (SSP) is typically conducted under vacuum or in a stream of purge gas such as nitrogen. Overall, SSP involves two major steps: (1) chemical reactions and (2) diffusion of reaction by-products. Typically, to force the polyester prepolymer to further polymerize during SSP, reaction by-products must be effectively removed as they are generated. By-products generated by the reactions diffuse from the interior to the surfaces of the pellets where they are removed by vacuum or an inert gas stream. Since resistance to by-product diffusion from the surfaces of the pellets to the bulk of the gas phase is negligible, only the chemical reaction rates and by-product diffusion from the interior to the surfaces of the pellets are major factors in polymerization performance.

Resistance to diffusion of by-products can be reduced by reducing prepolymer particle size. However, at a fixed temperature, smaller particles have higher tendencies to stick. Therefore, lower reaction temperatures are required if particle size is reduced. Moreover, excessively small particles are hard to handle.

Another way to reduce by-product diffusional resistance while maintaining pellet size is to increase the surface area to volume ratio of the pellets. Practically all standard prepolymer pellets have round, elliptical, square, rectangular, or other simple cross-sections. However, these simple cross-sections have low surface area to volume ratios.

One of the obstacles to producing commercially viable PEF bottles is that the mass transport rates of diluents via diffusion in PEF are so slow that conventional drying or SSP processing conditions used for commercial polyesters such as PET are not adequate to achieve the requisite performance. Consequently, compared to PET, drying and SSP times usually must be extended by up to 10 fold to accomplish equivalent pellet moisture and molecular weight in drying and SSP processes for PEF resins. For example, PET pellets normally dry over a four to six hour period under typical drying conditions (e.g. air temperature: 140-160° C., dew point temperature: −40° F.) whereas PEF pellets dry over a four to five day period under typical drying conditions (e.g. air temperature: 140-160° C., dew point temperature: −40° F.). Likewise, in typical PET SSP conditions, polymerization occurs over a 1-12 hour period to raise the IV from 0.30 dL/g to 0.65-0.85 dL/g whereas, in typical PEF SSP conditions, polymerization occurs over a 28-38 hour period to raise the IV from 0.83 dL/g to 0.93 dL/g.

The excessively long SSP times for PEF to build the requisite molecular weight (i.e. intrinsic viscosity of 0.90 dL/g or greater) for carbonated soft drink bottles adversely positions the manufacturing processing economics of PEF compared to PET. Means to process PEF more efficiently than PET are needed for biobased PEF to reach commercial parity with PET as a viable replacement resin for carbonated soft drink bottle production.

Prior approaches to reduce drying and SSP times have developed along two distinct pathways: porous pellets and shaped pellets. The porous pellets comprise foamed and sintered particles, whereas the shaped pellets have been hollow or open hollow along their length (i.e. “0” or “C” shaped). However, these approaches have only had limited success in reducing SSP times.

Among other things, the improved polyester prepolymer pellet forms of this disclosure offer enhanced prepolymer pellet drying and SSP rates and provide reduced diffusion resistance to reaction by-products. For example, in some embodiments, the prepolymer pellets disclosed herein are shaped to include an externally convoluted surface to overcome the disadvantages of the prior pellets. In some embodiments, the prepolymer pellets disclosed herein are shaped to include an internally convoluted surface to overcome the disadvantages of the prior pellets. In some embodiments, the prepolymer pellets disclosed herein are shaped to include both an externally convoluted surface and an internally convoluted surface to overcome the disadvantages of the prior pellets.

Moreover, the disclosures herein are applicable to virtually any polyester that can be dried or solid state polymerized. In some embodiments, the disclosure provides PEF or PEF co-polymer resin pellets.

Polyester prepolymers (starting polyesters) may be made by any suitable method but are typically prepared by conventional melt polymerization techniques using temperatures, catalysts, and stabilizers well known in the polyester art. These polyester prepolymers have a relatively low initial starting I.V.

The prepolymer is formed into multi-lobed resin pellets (granules) prior to solid state polymerization. In some embodiments, each of the pellets contains three or more lobes if externally lobed and/or two or more lobes if internally lobed. Suitable pellets can be advantageously formed by extruding the prepolymer through a specially designed die, quenching the extruded strands and chopping the solidified strands into pellets. The pellets will generally be cut into lengths of from about 1 mm to 10 mm. In some embodiments, lengths of 2 to 3 mm are preferred for pellets in the size range of about 0.5 to 5 grams per 100 pellets. Typically the general cross-sectional shape of the pellets is externally and/or internally (hollow) multi-lobed; however, the pellets can take on various other geometries or shapes.

The presence of multiple lobes in each pellet greatly shortens the by-product mean diffusion path and increases surface area, thereby lowering the overall by-product diffusional resistance within the pellet. Therefore, polyester prepolymer pellets with multiple lobes solid state polymerize much faster than prior known polyester prepolymer pellets.

In some embodiments, the pellets are formed by an extrusion-pelletizing technique. The pellets can be produced by discharging a prepolymer melt from a melt reactor through an extrusion die having multi-lobed orifices, quenching the extruded strands, and chopping the solidified strands with a pelletizer. As the extruded melt strands emerge from the die face, each strand will have a multi-lobed shaped cross-section. In some embodiments, the pellet exterior has a non-multilobe shape (e.g. cylindrical, round, elliptical, square, rectangular, etc.) and the pellet interior has one or more cavities using properly designed extrusion dies. The cavities allow air to enter the interior of each forming strand. Various capillary flow geometries for the strand die may be used in accordance with the various embodiments of this disclosure.

In some embodiments, it may be desirable to use extrusion dies with mandrels or similar devices. A mandrel is a hollow pin inserted in the center of a die orifice that forms the cavity. Air or nitrogen can be introduced though the center of the mandrel to fill the center of the extrudate, thus reducing the possibility of the cavity closing when quenched or in further processing. The mandrel may also be constructed in such a manner as to allow the ingress of air or the injection of air under pressure to maintain a hollow pellet. In some preferred embodiments, however, a flow cross-section comprises supporting webs in the die that allow heated air to escape from the interior of the strand prior to flow stream coalescence before the die bath.

Prior to solid state polymerization, the pellets may be dried to remove excess moisture. Using conventional pellets, PET pellets normally dry over a four to six hour period under typical drying conditions (e.g. air temperature: 140-160° C., dew point temperature: −40° F.) whereas PEF pellets dry over a four to five day period under typical drying conditions (e.g. air temperature: 140-160° C., dew point temperature: −40° F.).

For solid state polymerization, achieving conditions under which the prepolymer is partially crystalline reduces sticking. Since extruded pellets generally will be substantially amorphous, the pellets are usually processed to increase crystallinity to the desired level, which it typically done by heating. Crystallization is carried out in any suitable equipment in which the polyester granules can be heated to crystallization temperatures without sticking. Agitation normally helps prevent sticking. Crystallization can also be carried out in a fluidized bed crystallizer. Fluidization is accomplished by utilizing a gas flow rate sufficient to cause the pellets to be fluidized in the crystallizer with or without mechanical vibration. Inert gas or air can be used. Since very large quantities are required for fluidization, air is most economical.

In the case of PET, crystallization residence time is generally in the range of about 2 to about 20 minutes. Air at temperatures in the range of about 140° C. to about 215° C. is used for heating. In the case of PEF, crystallization residence time is longer than it is for PET. For PEF, air at temperatures in the range of about 140° C. to about 160° C. is used for heating.

Solid state polymerization (SSP) of the multi-lobed pellets is conducted at conditions suitable for polymerization of standard solid pellets of similar size. Generally SSP is conducted at a temperature of about 10° to about 50° C. below the melting point of the prepolymer. For PET, a temperature range of 200° to 255° C. is generally appropriate. For PEF, a temperature range of 175° to 215° C. is generally appropriate. The polymerization is conducted under vacuum or in a stream of inert gas in a suitable reactor. Using conventional pellets, PET polymerization typically occurs over a 1-12 hour period to raise the IV from 0.30 dL/g to 0.65-0.85 dL/g whereas PEF polymerization typically occurs over a 28-38 hour period to raise the IV from 0.83 dL/g to 0.93 dL/g.

The advantages of the prepolymer pellets with multiple lobes and other aspects of this disclosure and invention are demonstrated in the following Illustrative Embodiments.

### ILLUSTRATIVE EMBODIMENTS

Commercial polyester pellets generally are solid state polymerized to raise resin intrinsic viscosity and are dried prior to melt processing to reduce degradation. Disclosed is a process for producing polyester pellets yielding higher drying and SSP rates than conventional, cylindrical polyester pellets. The pellets of the present disclosure can provide several advantages over conventional pellets. First, pellets of the present disclosure can have an increased surface area/volume ratio relative to conventional pellets (e.g. solid cylindrical pellets) and, depending upon the pellet count, can yield higher SSP productivity. Second, pellets of the present disclosure can have thinner solid dimensions relative to conventional pellets (e.g. solid cylindrical pellets), which can provide for shorter diffusion paths for SSP reaction by-products and lead to shorter SSP times. This advantage can also translate into lower acetaldehyde and faster pellet drying times. Third, pellets of the present disclosure can have a greatly reduced potential for pronounced intraparticle molecular weight gradients within the pellets relative to conventional pellets (e.g. solid cylindrical pellets). Molecular weight gradients can manifest as excessive drop in preform IV and contribute, for example, to poor performance in reheat stretch blow molding processes. Fourth, externally and/or internally lobed pellets can be more crush-resistant and less prone to fragmentation/fracture in the pelletizing/strand cutting process relative to conventional pellets (e.g. solid cylindrical pellets). Fifth, pellets of the present disclosure can provide a more efficient pellet design, relative to conventional pellets (e.g. solid cylindrical pellets), that offers the ability to operate an SSP reactor with a lower molecular weight resin feed (IV) while ensuring adequate productivity.

In some embodiments, multi-lobed resin pellets can accelerate SSP and drying times 300% or more in comparison to conventional pellets by enhancing pellet surface area. Since SSP is diffusion limited, increasing the surface area to volume ratio results in a shorter diffusion paths and better SSP efficiency. In some embodiments, the external and/or internal surfaces of the pellet are highly convoluted, which will improve intraparticle diffusion mass transfer rates resulting in a reduction of pellet drying and SSP processing times.

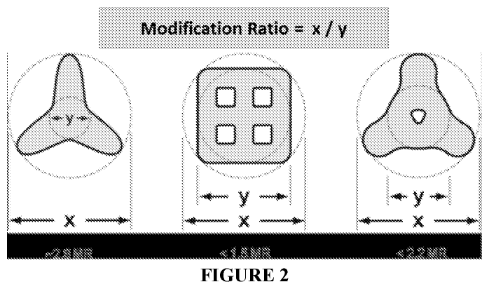

In some embodiments, the multi-lobed pellets are characterized by their modification ratio (MR). To calculate the modification ratio, the size of the outer circle's circumference of the pellet is compared to the size of the inner circle's circumference. In embodiments where a pellet exterior has a non-multilobe shape (e.g. cylindrical, round, elliptical, square, rectangular, etc.) and the pellet interior is hollow and multilobed with uncoalesced lobes, the MR is defined by the inverse ratio of the outerscribed diameter to the internal diameter determined by the locus of lobe peaks. In embodiments where a pellet exterior has a non-multilobe shape (e.g. cylindrical, round, elliptical, square, rectangular, etc.) and the pellet interior is hollow and multilobed with coalesced internal lobes, the modification ratio is defined as the ratio of the externally circumscribed diameter to the diameter of the solid section of the internal coalesced lobes. In FIG. 2, the modification ratio for an externally lobed pellet crossection is equal to X/Y. If the ratio of outer and inner radii of the multilobed pellets (i.e. modification ratio) is properly scaled, higher drying and SSP processing rates may be realized without encountering significant erosion or breakage of pellet lobes which may lead to dust and fines development in pellet air conveying processes. A similar observation results if the pellet (1) has a multilobed exterior (i.e. externally lobed) and an interior which is hollow and internally lobed with a coalesced or uncoalesced lobe structure; or (2) has a non-multilobe shaped (e.g. cylindrical, round, elliptical, square, rectangular, etc.) exterior and an interior which is hollow and internally lobed with a coalesced or uncoalesced lobe structure.

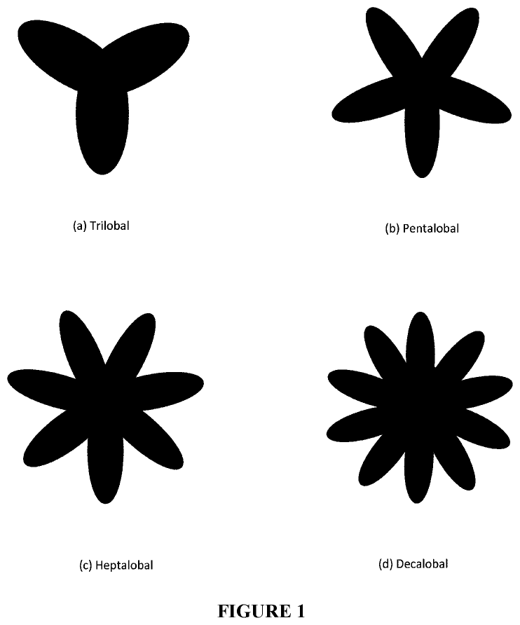

In some embodiments, cut strands extruded from multilobed capillaries are used to form resin pellets having highly convoluted external and/or internal surfaces, an example of which is shown in FIG. 1. Forming the pellets in this manner, as opposed to prior polymer melt extrusion based approaches, yields significantly higher particle surface area to volume ratios leading to faster moisture diffusion rates during drying and accelerated SSP rates. Additionally, if the ratio of outer and inner radii of the multilobed pellets (i.e. modification ratio) is properly scaled, higher drying and SSP processing rates may be realized without encountering significant erosion or breakage of pellet lobes which may lead to dust and fines development in pellet air conveying processes.

In some embodiments, the prepolymer pellets disclosed herein are shaped to include an externally and/or internally convoluted surface to overcome the disadvantages of the prior pellets. Within the context of this disclosure “externally convoluted” describes a surface in which the local curvature of the surface is varied between concave outward and concave inward in such a manner as to yield a multi-lobed surface that provides for significantly greater surface area to volume ratio for the polymer pellet.

Unlike prior shaped pellets produced using a singly curved external surface (i.e. cylindrical external geometry) for producing hollow or C-shaped pellets, the presently disclosed pellets utilize multiply-inflected curved external and/or internal surfaces (multi-lobed geometry) to shape the pellets through the use of appropriately configured extrusion dies.

In some embodiments, the prepolymer pellets can have 3, 4, 5, 6, 7, 8, 9, 10, 11, 12, 13, 14, 15, 16, 17, 18, 19, 20, 25, 30, 35, 40, 45, 50, or more lobes if externally lobed, and/or 2, 3, 4, 5, 6, 7, 8, 9, 10, 11, 12, 13, 14, 15, 16, 17, 18, 19, 20, 25, 30, 35, 40, 45, 50, or more lobes if internally lobed.

### Example 1: Capillary Design—Hendecalobal Pellet (11 Lobes)

In one embodiment, a hendecalobal pellet is provided and was processed using a die having the following geometry and processing characteristics.

TABLE 1
Hendecalobal Pellet

| | Value | Units | Comment(s) |
|---|---|---|---|
| Process Variable | | | |
| Melt Temperature | 290.0 | ° C. | |
| Melt Density | 1.161 | g/cm² | |
| Intrinsic Viscosity | 0.840 | dL/g | |
| Reference Temperature | 290.0 | ° C. | |
| Horizontal TTS Shift | 1.108 | — | |
| Factor, aT | | | |
| Zero-Shear Viscosity | 7,025 | poises | |
| Melt Flow Rate (Volume) | 2.00 | cm³/s | |
| Melt Flow Rate (Mass) | 2.32 | g/s | |
| Capillary Design Specification | | | |
| Number of Lobes | 11 | — | Heptal obal |
| | | | crossection |
| Lobe Width | 0.33 | mm | |
| Lobe Length | 0.66 | mm | |
| Die Length | 5.00 | mm | |
| Lead Bore Diameter | 4.00 | mm | |
| Flow Entry Angle | 60.0 | Degrees | Standard flow entry |
| | | | angle of 60° to |
| | | | match lead bore |
| Capillary Length | 4.41 | mm | |
| Capillary Characteristics | | | |
| Wetted Perimeter | 20.09 | mm | |
| Cross-Section Area | 3.836 | mm² | |
| Hydraulic Diameter | 0.764 | mm | |
| Length to Diameter | 5.78 | — | |
| Ratio (L/D) | | | |
| Inner Circumscribed | 1.16 | mm | |
| Diameter | | | |
| Outer Circumscribed | 2.76 | mm | |
| Diameter | | | |
| Maximum | 2.37 | — | |
| Modification Ratio | | | |
| Miller Shape Factor | 6.86 | — | |
| Apparent Shear Rate | 2,340 | s⁻¹ | |
| Actual Wall Shear Rate | 2,582 | s⁻¹ | |
| Actual Shear Viscosity | 2,876 | Poises | |
| Wall Shear Stress | 7.42E+06 | Dynes/cm² | |
| Capillary Pressure Drop | 2,489 | Psig | Capillary pressure drop only. |
| | | | Entrance and exit pressure |
| | | | losses are not considered. |
| Pellet Characteristics | | | |
| Polymer Density | 1.335 | g/cm³ | |
| (25° C.) | | | |
| Pellet Length | 2.52 | mm | |
| Cross-Section Area | 3.84 | mm² | |
| Dimensionless | 15.20 | — | |
| Surface Area | | | |
| Pellet Volume | 9.67 | mm³ | |
| Pellet Count | 72 | g⁻¹ | Based upon capillary |
| | | | cross-section. |
| | | | Die swell neglected. |

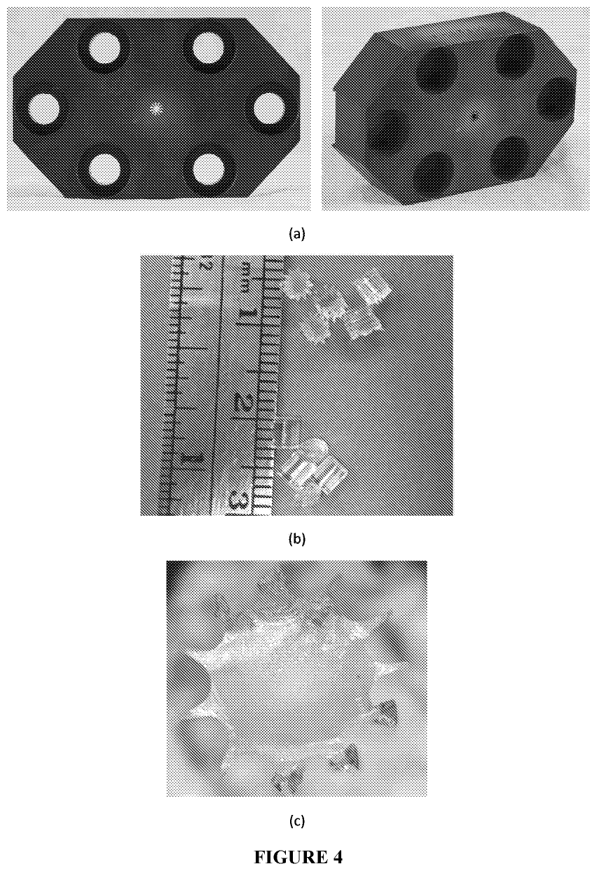

The die design summarized in Table 1 was fabricated according to the schematic in FIG. 4.

### Example 2: SSP Rate Comparison of Standard Cylindrical and 11-Lobe PET Pellets

In a first study, Indorama 7000A PET resin (0.52 dL/g) was used to characterize the improvement in solid stating rate with a larger surface area pellet fabricated, using a die, with an 11-lobe (hendecalobal) geometry. Two separate extrusion batches were produced: once comprising a standard cylindrical strand, and the second an 11-lobed strand extruded using the die specified in Example 1. The Werner & Phleiderer ZSK 30 mm twin screw compounding conditions were optimized to create a uniform feed with a strand thickness similar to commercially produced PET and pellet count was in the 70-75 pellets/gram range. Strand extrusion and pelletization conditions were as follows:

TABLE 2
Strand extrusion and pelletization conditions

| | | Standard | |
|---|---|---|---|
| | | Cylindrical | 11-Lobe |
| Process Variable | Description | Pellet | Pellet |
| Barrel Temperature | Zone 1 | 240 | 240 |
| (° C.) | Zone 2 | 255 | 255 |
| | Zone 3 | 260 | 260 |
| | Zone 4 | 275 | 275 |
| | Adapter | 275 | 275 |

| | | |
|---|---|---|
| Throughput (lbₘ/hr) | 22.5 | 21.0 |
| Pellet Cut length (mm) | 3.2 | 3.2 |
| Pellet Count (g⁻¹) | 58 | 58 |

The resulting pellets were solid state polymerized (SSP) in two individual 5 lbₘ batches at 210° C. for 10 hours. The PET intrinsic viscosity (IV) was measured at two-hour sampling intervals starting with an initial sample measurement (0 hr) and concluding with a final sample measurement (10 hours) for each SSP batch.

In more detail, the resulting compounded materials were crystallized in a convection oven at 150° C. for four hours and then dried in a desiccant dryer at 145° C. prior to solid state polymerization in a small SSP reactor. Approximately five pounds was processed for each batch. The temperature was raised to 210° C. and held at this temperature for 10 hours. Samples were taken every two hours for IV measurements after reaching the 210° C. set point. After 10 hours, the resin was cooled under a nitrogen atmosphere and removed from the solid stating device. The recorded sample IV and IV build rates (computed using backward differences) are summarized in the table below. Under identical solid stating conditions and time, the IV build for the 11-lobe pellet was 0.154 dL/g compared to 0.141 dL/g for the cylindrical pellet. This difference may be further increased as the solid stating time is extended; based upon linear regression, the time for the standard pellet to reach 0.90 dL/g IV is expected to be 1.5 hours longer than the lobed pellet.

TABLE 3
Recorded sample IV and IV build rates for PET
cylindrical pellets and PET 11-lobe pellets

| | | Indorama | | Indorama |
|---|---|---|---|---|
| | Indorama | 7000A PET | Indorama | 7000A PET |
| SSP | 7000A PET | Cylindrical | 7000A PET | 11-Lobe |
| Reaction | Cylindrical | Pellet | 11-Lobe | Pellet |
| Time | Pellet IV | IV Lift Rate | Pellet IV | IV Lift Rate |
| (hr) | (dL/g) | (dL/g · h) | (dL/g) | (dL/g) |
| 0 | 0.516 | 0.0175 | 0.522 | 0.0150 |
| 2 | 0.551 | 0.0135 | 0.552 | 0.0125 |
| 4 | 0.578 | 0.0130 | 0.577 | 0.0130 |
| 6 | 0.604 | 0.0060 | 0.603 | 0.0175 |
| 8 | 0.616 | 0.0185 | 0.638 | 0.0120 |
| 10 | 0.653 | — | 0.662 | — |

### Example 3: Capillary Die Design Yielding Four Internally Coalesced Lobes (4T Die)

In one embodiment, a capillary die was designed to yield an outwardly cylindrical pellet (i.e. a pellet having a non-multilobe shape exterior) with four internal, coalesced lobes. The resulting die design was characterized by the geometry and processing characteristics summarized in the table below.

TABLE 4
Pellet With Four Internally Coalesced Lobes

| Parameter | Symbol | Value | Units | Value | Units |
|---|---|---|---|---|---|
| First Outerscribed Circle Diameter | D₁ | 7.25 | mm | 0.725 | cm |
| Second Outerscribed Circle Diameter | D₂ | 5.96 | mm | 0.596 | cm |
| Innerscribed Support Diameter | Dᵢ | 1.493 | mm | 0.1493 | cm |
| Flow Element Arc Angle | θ_{f} | 2.906 | rad | 166.5 | degrees |
| Support Element Arc Fraction | fₛ | 0.075 | — | — | — |
| Support Element Arc Angle | θₛ | 0.236 | rad | 13.50 | degrees |
| Number of Support Elements | Nₛ | 2 | — | — | — |
| Flow Leg Arc Angle | θ_{L} | 0.210 | rad | 12.03 | degrees |
| Flow Leg Width | w | 0.625 | mm | 0.0625 | cm |
| Flow Leg Length | L | 2.20 | mm | 0.220 | cm |
| Flow Leg L/w | L/w | 3.52 | — | — | — |
| Outer Support Ligament Width (minimum) | xₑ | 0.702 | — | — | — |
| Inner Support Ligament Width | xᵢ | 0.614 | — | — | — |
| Capillary Flow Area | A_{c} | 13.770 | mm² | 0.1377 | cm² |
| Wetted Perimeter | P | 24.88 | mm | 2.488 | cm |
| Hydraulic Diameter | Dₕ | 2.21 | mm | 0.221 | Cm |
| Melt Flow Rate | G | 0.731 | g/s | 5.80 | lbₘ/h |
| Polymer Melt Density | ρ | 1.290 | g/cm³ | 80.5 | lbₘ/ft³ |
| Extrusion Velocity | v₀ | 2.06 | cm/s | 0.067 | ft/s |
| Capillary Open Area Fraction (calculated) | f_{A} | 0.333 | — | — | — |
| Capillary Open Area Fraction (measured) | f_{A} | 0.608 | — | — | |
| Miller Shape Factor | K | 24.0 | — | — | — |
| Average Wall Shear Rate | γₐₚₚ | 9.92 | s⁻¹ | — | — |
| Extrusion Temperature | T₀ | 272.0 | ° C. | — | — |
| Intrinsic Viscosity | IV | 0.900 | dL/g | — | — |
| Shear Viscosity | η | 948 | Pa · s | 9,479 | Poises |
| Actual Shear Rate | γ | 9.96 | s⁻¹ | — | — |
| Wall Shear Stress | τ | 18,810 | Pa | 2.73 | Psi |
| Capillary Length | L_{C} | 7.84 | mm | 0.784 | Cm |
| Capillary L/D | L_{C}/Dₕ | 3.54 | — | — | — |
| Capillary Pressure Drop | Δρ | 266,471 | Pa | 38.6 | psi |
| Force on External | Fₑ | 1.24 | lb_{f} | — | — |
| Supported Area/Ligament | | | | | |
| Force on Inner | Fᵢ | 0.052 | lb_{f} | — | — |
| Supported Area/Ligament | | | | | |
| Estimated Drawdown Ratio | v_{f}/v₀ | 7.12 | — | — | — |
| Pellet Length | Lₚ | 3.00 | mm | 0.300 | Cm |
| Pellet L/D | Lₚ/Dₚ | 1.10 | — | — | — |
| Estimated Pellet Count | N_{P} | 67 | pellets/g | — | — |
| Young's Modulus | E | 28,000,000 | psi | — | — |
| Web Moment of Inertia | I | 28.2 | mm⁴ | 6.77E−05 | in⁴ |
| Web Deflection | δ | 2.79E−04 | mm | 1.10E−05 | in |
| Yield Stress | σ_{y} | 215 | MPa | 31,183 | psi |
| Shear Stress | Σ | 1.00 | MPa | 145 | psi |

### Example 4: SSP Rate Comparison of Standard Cylindrical and 4T Die Produced PET Pellets

A second study was conducted using a nominal 0.83 dL/g PET resin (Indorama 1101) and the 4T die described in Example 3 to characterize the improvement in solid stating rate with a larger surface area pellet. Two separate extrusion batches were produced: one comprising a standard cylindrical strand, and the second an outwardly cylindrical and internally coalesced 4-lobed hollow strand (4T hollow). The Werner & Phleiderer ZSK 30 mm twin screw compounding conditions were optimized to create a uniform feed with a strand thickness similar to commercially produced PET. The pellet count was in the 63-65 pellets/gram range and the pellets had an average pellet cut length of about 3.2 mm. Strand extrusion and pelletization conditions were as follows:

TABLE 5
Strand extrusion and pelletization conditions

| | | Indorama 1101 | |
|---|---|---|---|
| | | Standard | Indorama 1101 |
| | | Cylindrical | 4T Hollow |
| Process Variable | Description | Pellet | Pellet |
| Barrel Temperature | Zone 1 | 235 | 235 |
| (° C.) | Zone 2 | 255 | 255 |
| | Zone 3 | 260 | 260 |
| | Zone 4 | 265 | 265 |
| | Adapter | 270 | 275 |

| | | |
|---|---|---|
| Throughput (lbₘ/hr) | 15.6 | 17.2 |
| Pellet Cut Length (mm) | 3.2 | 3.2 |
| Pellet Count (g⁻¹) | 75 | 73 |

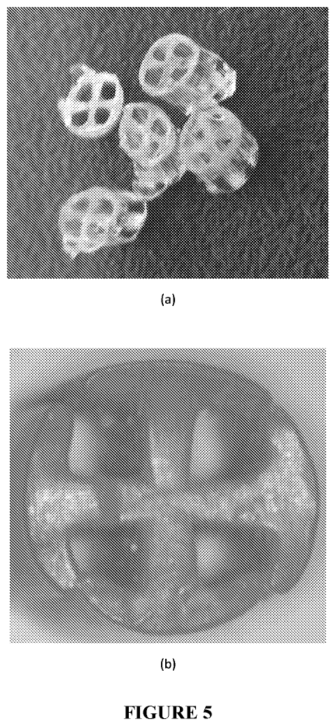

The resulting PET pellets yielded excellent coalesced 4T shape definition as shown in FIG. 5. The pelletized materials were crystallized in a convection oven for a minimum of six hours at 270° F. (132° C.). Three-pound batches of Indorama 1101 PET pellets were loaded into a bench-top solid stating unit and solid state polymerized (SSP was performed for up to 105 hours at 385° F. (196° C.). During SSP, the resin was intermittently mixed within the SSP reactor to ensure uniformity and good heat contact. A continuous flow of nitrogen was supplied to the SSP reactor to remove polymerization byproducts. The SSP reactor was sampled at regular intervals over the course of the 105 hours, with more frequent sampling in the first 24 hours. Following solid-state polymerization, the resin was cooled under a nitrogen atmosphere and removed from the SSP reactor. The recorded sample IV and IV build rates are summarized in the table below.

TABLE 6
Recorded sample IV and IV build rates for
PET cylindrical pellets and PET 4T pellets

| | | Indorama | | |
|---|---|---|---|---|
| | Indorama | 1101 | | |
| | 1101 | Standard | | Indorama |
| SSP | Standard | Cylindrical | Indorama | 1101 4T |
| Reaction | Cylindrical | Pellet IV | 1101 4T | Pellet IV |
| Time | Pellet IV | Lift Rate | Pellet IV | Lift Rate |
| (hr) | (dL/gh) | (dL/gh) | (dL/g) | (dL/g) |
| 0.0 | TBD | TBD | 0.831 | 0.0239 |
| 7.0 | TBD | TBD | 0.998 | 0.0171 |
| 23.5 | TBD | TBD | 1.280 | 0.0132 |
| 31.0 | TBD | TBD | 1.379 | 0.0081 |
| 48.0 | TBD | TBD | 1.516 | 0.0073 |
| 55.0 | TBD | TBD | 1.567 | 0.0050 |
| 72.0 | TBD | TBD | 1.652 | — |

Comparing the data for PET in the foregoing table with the data in Example 2, it can be seen that, starting from an initial IV of 0.831 dL/g, an IV of 0.998 dL/g was achieved in 7 hours with the pellet produced with the 4T die. This yields an initial SSP rate of 0.024 dL/g·h, which corresponds to an initial SSP rate at least 36% higher than for the standard cylindrical or hendecalobal mutilobed PET pellet, despite the lower starting IV in Example 2.

### Example 5: Drying Rate Comparisons of Standard Cylindrical and 4T Die Produced PET Pellets

A third study was conducted to compare the effect of pellet geometry on drying time and rate, and the study used PET (Indorama 1101) pellets produced with the 4T die and standard, as-received, Indorama 1101 cylindrical pellets. In both cases, the resin was dried in a desiccant dryer at 145° C. using −42° F. dew point air flow at 1.0 scfm/lbₘ for at least 8 hours, and moisture content was sampled at 2-hr intervals. The resulting data, summarized in the table below, shows that drying to 50 ppm is essentially complete in about 2 hours for the 4T pellet, whereas the drying time for the standard cylindrical pellet was about 6 hours.

TABLE 7
Moisture Content of PET Standard Pellets and 4T Hollow Pellets

| | Moisture | Moisture |
|---|---|---|
| | Content (ppm) | Content (ppm) |
| Drying Time | of PET | of PET 4T |
| (hrs) | Standard Pellet | Hollow Pellet |
| 0.0 | 3,073 | 2,669 |
| 2.0 | 82 | 20 |
| 4.0 | 229 | 55 |
| 6.0 | 66 | 73 |
| 8.0 | 9 | 19 |

Those skilled in the art will appreciate that modifications are possible in the exemplary embodiments disclosed herein without materially departing from the novel teachings and advantages according to this disclosure. Accordingly, all such modifications and equivalents are intended to be included within the scope of this disclosure as defined in the following claims.

1. A method for producing polyester pellets, the method comprising:
extruding a polyester polymer melt through a multilobed capillary to form a multilobed polyester polymer strand; and
separating the polyester polymer strand to form multilobed polyester resin pellets.

2. The method of claim 1, further comprising quenching the multilobed polyester resin pellets.

3. The method of claim 2, further comprising solid state polymerizing the multilobed polyester resin pellets under an inert gas or under partial vacuum.

4. The method of claim 1, wherein the polyester is a poly(ethylene terephthalate), a poly(ethylene furanoate), a poly(ethylene terephthalate) co-polymer, or a poly(ethylene furanoate) co-polymer.

5. The method of claim 1, wherein the multilobed polyester resin pellets have a modification ratio of 1.05 or greater.

6. The method of claim 1, wherein the multilobed polyester resin pellets have two or more lobes.

7. The method of claim 1, wherein the multilobed polyester resin pellets have a polymer density of about 1.1-1.8 g/cm³ (25° C.) and a length of about 2-3 mm.

8. The method of claim 1, wherein the multilobed polyester resin pellets have a polymer density of about 1.3 g/cm³ (25° C.), a length of about 2.5 mm, a cross-sectional area of about 3.8 mm2, and a volume of about 9-10 mm³.

9. The method of claim 1, wherein the multilobed polyester resin pellets have at least a 10% faster solid state polymerization rate than cylindrical pellets having an equivalent mass.

10. The method of claim 1, wherein the multilobed polyester resin pellets have at least a 10% faster moisture drying rate than cylindrical pellets having an equivalent mass.

11. The method of claim 1, wherein the multilobed polyester resin pellets have an intrinsic viscosity of about 0.25 dl/g or greater.

12. The method of claim 1, wherein the polyester polymer melt is extruded through an externally multilobed capillary to form an externally multilobed polyester polymer strand.

13. The method of claim 1, wherein the polyester polymer melt is extruded through a hollow, internally multilobed capillary to form a hollow, internally multilobed polyester polymer strand.

14. The method of claim 13, wherein the hollow, internally multilobed polyester polymer strand has a coalesced lobe structure.

15. The method of claim 13, wherein the hollow, internally multilobed polyester polymer strand has an uncoalesced lobe structure

16. The method of claim 1, wherein the polyester polymer melt is extruded through an externally multilobed and hollow, internally multilobed capillary to form an externally multilobed and hollow, internally multilobed polyester polymer strand.

17. A multilobed polyester resin pellet made according to claim 1.

18. A method for preparing a polyester polymer, the method comprising:
drying one or more multilobed polyester resin pellets made according to claim 1; and
solid state polymerizing the one or more multilobed polyester resin pellets to form a polyester polymer having an intrinsic viscosity of about 0.65 dl/g or greater.

19. A method for preparing a polyester polymer, the method comprising:
drying one or more multilobed polyester resin pellets made according to claim 1 at a temperature range from about 140° C. to 160° C. at a dew point temperature of about −40° C. for less than four days; and
solid state polymerizing the one or more multilobed polyester resin pellets to form a polyester polymer having an intrinsic viscosity of about 0.65 dl/g or greater.

20. The method of claim 19, wherein the polyester polymer has an intrinsic viscosity of about 0.90 dl/g or greater.
